(19) United States
(12) Patent Application Publication
(10) Pub. No.: US 2018/0174736 A1
(43) Pub. Date: Jun. 21, 2018

(54) INDUCTOR AND MANUFACTURING METHOD OF INDUCTOR

(71) Applicant: SAMSUNG ELECTRO-MECHANICS CO., LTD., Suwon-si (KR)

(72) Inventors: Yong Hui LI, Suwon-si (KR); Jae Hun KIM, Suwon-si (KR); Eo Jin CHOI, Suwon-si (KR); Young Ku RYU, Suwon-si (KR)

(21) Appl. No.: 15/645,389

(22) Filed: Jul. 10, 2017

(30) Foreign Application Priority Data
Dec. 15, 2016 (KR) 10-2016-0171817

(51) Int. Cl. H01F 27/28; H01F 27/29; H01F 41/04; H01F 27/255

(52) U.S. Cl. CPC H01F 27/2804; H01F 27/29; H01F 2027/2809; H01F 27/255; H01F 41/042

(57) ABSTRACT

An inductor includes a body and a coil part disposed in the body, the coil part including a coil layer, the coil layer including a coil pattern having a spiral shape and a lead terminal extended from the coil pattern and exposed to an outside of the body, wherein a width of the lead terminal is the same as that of the coil pattern.

### CROSS-REFERENCE TO RELATED APPLICATION(S)

This application claims the benefit of priority to Korean Patent Application No. 10-2016-0171817, filed on Dec. 15, 2016 with the Korean Intellectual Property Office, the disclosure of which is incorporated herein by reference in its entirety.

### TECHNICAL FIELD

The present disclosure relates to an inductor and a manufacturing method thereof.

### BACKGROUND

In accordance with trends toward miniaturization and thinness of electronic devices such as digital TVs, mobile phones, laptop computers, and the like, there has also been a demand for miniaturization and thinness of inductors used in these electronic devices. In order to satisfy this demand, research into a winding type or a thin film type inductors having various shapes has been actively conducted.

In accordance with this trend toward miniaturization and thinness of the inductor, implementation of characteristics equivalent to those in existing inductors, notwithstanding their being miniaturized and thin, has become a major issue. In order to satisfy the requirements described above, there is a need to increase the volume of magnetic material and significantly decrease the volume of insulating material in the inductor, to secure low direct current resistance (Rdc).

### SUMMARY

An aspect of the present disclosure may provide an inductor capable of decreasing a width of a lead terminal of a coil layer to decrease a pattern defect and a chipping defect of a body, and a manufacturing method thereof.

According to an aspect of the present disclosure, an inductor may include: a body in which a coil part including a coil layer is disposed, wherein the coil layer includes a coil pattern having a spiral shape and a lead terminal extended from the coil pattern and exposed to the outside of the body, the lead terminal having the same width as that of the coil pattern.

### BRIEF DESCRIPTION OF THE DRAWINGS

The above and other aspects, features, and advantages of the present disclosure will be more clearly understood from the following detailed description taken in conjunction with the accompanying drawings, in which:

FIG. 1 is a perspective view of an inductor according to exemplary embodiments of the present disclosure;

FIG. 2 is a cross-sectional view taken along line I-I′ of FIG. 1;

FIGS. 3 through 5 are plan views of a coil pattern of an inductor according to exemplary embodiments of the present disclosure; and

FIGS. 6 and 7 are cross-sectional views for describing a manufacturing method of an inductor according to exemplary embodiments of the present disclosure.

### DETAILED DESCRIPTION

Hereinafter, exemplary embodiments of the present disclosure will now be described in detail with reference to the accompanying drawings.

Hereinafter, an inductor according to exemplary embodiments of the present disclosure will be described with reference to the accompanying drawings. For convenience, a structure of a thin film inductor is described by way of example of the inductor, but the inductor according to the present disclosure may be applied to inductors for various purposes.

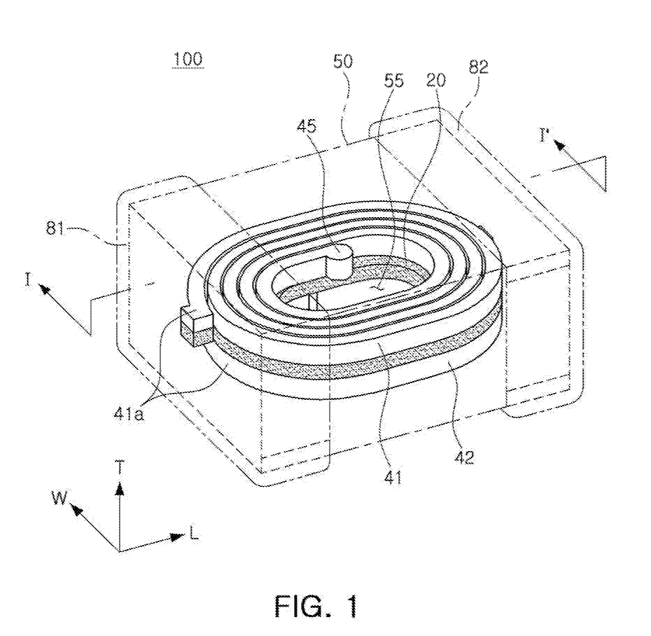

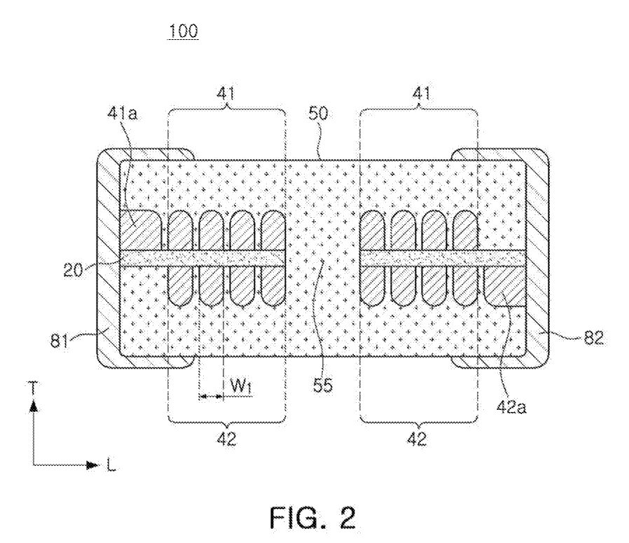

FIG. 1 is a perspective view of an inductor according to exemplary embodiments of the present disclosure, and FIG. 2 is a cross-sectional view of the inductor of FIG. 1 taken along line I-I′ of FIG. 1.

Referring to FIGS. 1 and 2, an inductor 100 according to exemplary embodiments of the present disclosure may include: a body in which a coil part including a coil layer is disposed, wherein the coil layer includes a coil pattern having a spiral shape and a lead terminal extended from the coil pattern and exposed to the outside of the body, the lead terminal having the same width as the coil pattern.

The body 50 may form an exterior of the inductor. L, W, and T illustrated in FIG. 1 refer to a length direction, a width direction, and a thickness direction, respectively. A shape of the body may be a hexahedron having first and second surfaces opposing each other in a stacking direction of the coil pattern (the thickness direction), third and fourth surfaces opposing each other in the length direction, and fifth and sixth surfaces opposing each other in the width direction, but is not limited thereto. Corners at which the first to sixth surfaces meet each other may be formed to be round by grinding, or the like.

The body 50 may contain a magnetic material having magnetic properties.

The magnetic material may be, for example, ferrite or a resin containing metal magnetic particles.

The body 50 may be formed of a material in which the ferrite or the metal magnetic particles are dispersed in a resin.

An example of the ferrite may include Mn—Zn based ferrite, Ni—Zn based ferrite, Ni—Zn—Cu based ferrite, Mn—Mg based ferrite, Ba based ferrite, Li based ferrite, or the like.

The metal magnetic particle may contain any one or more selected from the group consisting of iron (Fe), silicon (Si), chromium (Cr), aluminum (Al), nickel (Ni), and phosphorus (P). For example, the metal magnetic powder may contain a Fe—Si—B—Cr-based amorphous metal, but is not necessarily limited thereto. The metal magnetic material may have a particle diameter of 0.1 μm to 60 μm.

The resin may be a thermosetting resin such as an epoxy resin, a polyimide resin, or the like.

The coil part may perform various functions in an electronic device through properties appearing in a coil of the inductor 100. For example, the inductor 100 may be a power inductor. In this case, the coil part may serve to store electricity in a magnetic field form to maintain an output voltage, thereby stabilizing power, or the like.

The coil part may include a support member 20, and coil layers 41 and 42 formed on upper and lower surfaces of the support member. In detail, the coil part may include a first coil layer 41 formed on one surface of the support member and a second coil layer 42 formed on the other surface of the support member. The first and second coil layers 41 and 42 may be disposed to face each other based on the support member 20.

The first coil layer 41 may include a first coil pattern having a spiral shape and a first lead terminal 41a extended from the first coil pattern and exposed to the outside of the body, and the second coil layer 42 may include a second coil pattern having a spiral shape and a second lead terminal 42a extended from the second coil pattern and exposed to the outside of the body.

The first and second lead terminals 41a and 42a may be exposed to both surfaces of the body opposing each other among the surfaces of the body.

The first and second coil layers 41 and 42 may be formed using a photo-lithography method and a plating method.

As a novel coil formation method, walls may be formed between coils using the photo-lithography method and the coil may be formed therebetween (between the walls) using the plating method. Here, the lead terminal of the coil may be patterned so as to have a width equal to or wider than that of the coil pattern. In this case, as a length of the lead terminal is increased, and the width of the lead terminal is further increased as compared to the width of the coil pattern, before the coil is formed, a partial collapse of the wall may further occur in the vicinity of the lead terminal due to a difference in area between the lead terminal and the coil pattern. Further, as the width of the lead terminal is further increased as compared to the width of the coil pattern, a chipping phenomenon may further occur in a chip electrode portion due to difference in strength with a material filled in the body at the time of dicing.

According to exemplary embodiments of the present disclosure, a width Wa of the first and second lead terminals may be the same as a width Wb of the first and second coil patterns.

When the width of the first and second lead terminals is the same as that of the first and second coil patterns, a pattern defect and a chipping defect of the body may be decreased.

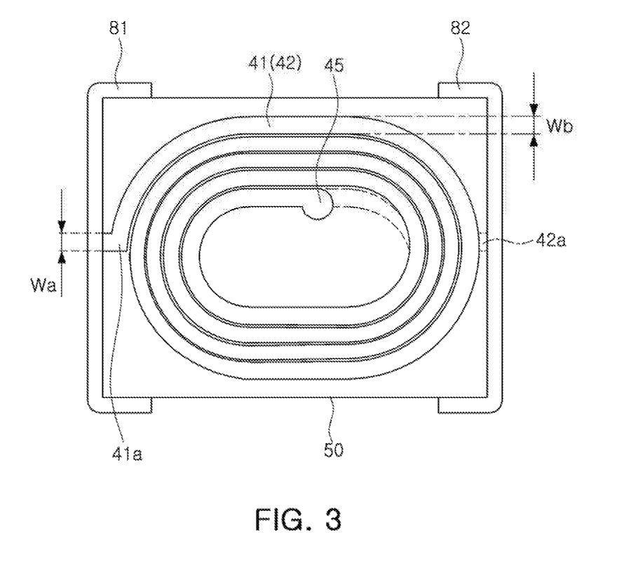

FIGS. 3 through 5 are plan views of a coil pattern in an inductor according to exemplary embodiments of the present disclosure.

Referring to FIG. 3, the first and second lead terminals 41a and 42a may be formed to be extended from the first and second coil patterns to thereby be exposed to both end surfaces of the body.

The first and second lead terminals 41a and 42a may be extended from the first and second coil patterns in the length direction of the body.

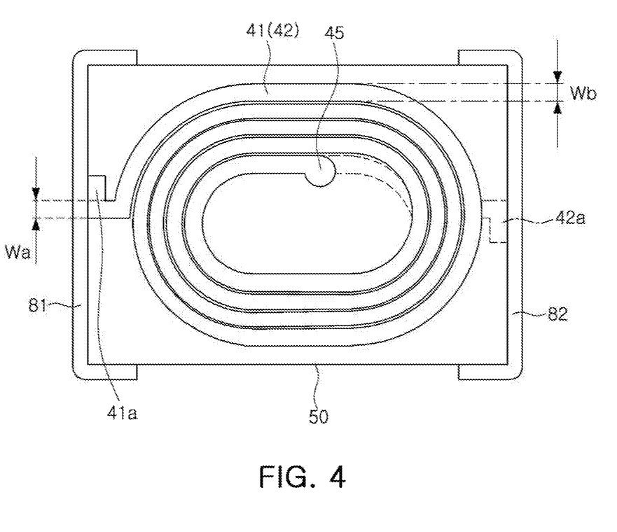

Referring to FIG. 4, the first and second lead terminals may each have a pattern having a letter “L” shape.

The first and second lead terminals 41a and 42a may be extended from the first and second coil patterns in the length direction of the body and then bent in the width direction of the body.

In the first and second lead terminals, a space between the lead terminal spaced apart from the coil pattern in the length direction of the body and the coil pattern may be filled with a material forming the body.

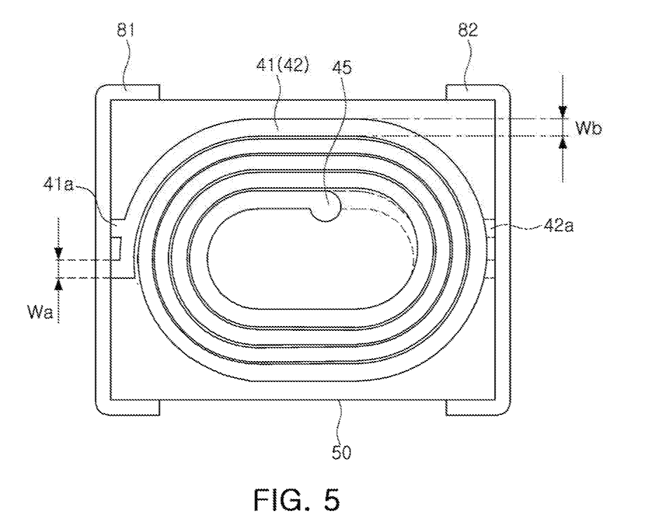

Referring to FIG. 5, the first and second lead terminals may each have a plurality of protrusion portions.

A width Wa of the protrusion portions of the first and second lead terminals may be the same as the width Wb of the coil pattern.

A space between the plurality of protrusion portions may be filled with the material forming the body.

The kind and a material of support member 20 are not particularly limited as long as the support member 20 may support the first and second coil patterns 41 and 42. For example, the support member may be a copper clad laminate (CCL), a polypropylene glycol (PPG) substrate, a ferrite substrate, a metal based soft magnetic substrate, or the like. In addition, the support member may be an insulating substrate formed of an insulating resin. As the insulating resin, a thermosetting resin such as an epoxy resin, a thermoplastic resin such as polyimide, or resins in which a reinforcement material, such as a glass fiber or an inorganic filler, is impregnated in the thermosetting resin and the thermoplastic resin, for example, a prepreg, an ajinomoto build-up film (ABF), FR-4, a bismaleimide triazine (BT) resin, a photo imageable dielectric (PID) resin, or the like, may be used. In view of maintaining rigidity, an insulating substrate containing glass fiber and the epoxy resin may be used, but the support member is not limited thereto.

A hole penetrating through central portions of the upper and lower surfaces of the support member 20 may be formed and filled with a magnetic material such as ferrite, metal magnetic particles, or the like, thereby forming a core part 55. As the core part 55 filled with the magnetic material may be formed, inductance L may be improved.

The first and second coil patterns 41 and 42 stacked on both surfaces of the support member may be electrically connected to each other through a via, or aperture, 45 penetrating through the support member.

The via 45 may be formed by forming a through hole using a mechanical drill, a laser drill, or the like, and then filling a conductive material in the through hole by a plating method.

A shape or a material of the via 45 are not particularly limited as long as the first and second coil patterns 41 and 42 disposed on both surfaces of the support member 20 to be positioned on the upper side and the lower side of the support member 20, respectively, may be electrically connected to each other. Here, the upper side and the lower side may be determined based on the stacking direction of the coil pattern in the accompanying drawings.

The via 45 may contain a conductive material such as copper (Cu), aluminum (Al), silver (Ag), tin (Sn), gold (Au), nickel (Ni), lead (Pb), an alloy thereof, or the like.

At the time of forming the via 45, the thicker the thickness of the support member, the larger the size of the via 45. Here, when the size of the via 45 is increased, a volume of the coil may be increased, and a non-magnetic region in the inductor may be increased, such that current characteristics to be implemented by the inductor may be deteriorated.

A cross section of the via 45 may have a trapezoidal shape or sandglass, or hourglass, shape.

The cross section of the via 45 may have the sandglass shape. This shape may be implemented by processing the upper or lower surface of the support member, such that a width of the cross section of the via 45 may be decreased. The width of the cross section of the via 45 may be 60 to 80 μm, but is not limited thereto.

The first and second coil layers 41 and 42 may be coated with an insulating film (not illustrated), and does not contact the magnetic material forming the body.

The insulating film may serve to protect the first and second coil layers.

A material of the insulating film is not limited as long as it contains an insulating material. For example, the insulating film may contain an insulating material used in general insulating coating, for example, an epoxy resin, a polyimide resin, a liquid crystal polymer, or the like, and a photo imageable dielectric (PID) resin known in the art, or the like, may also be used. However, the insulating film is not limited thereto.

First and second external electrodes 81 and 82 may be electrically connected to the first and second lead terminals exposed to both end surfaces of the body, respectively.

The first and second external electrodes 81 and 82 may serve to electrically connect the coil part to an electronic device at the time of mounting the inductor 100 in the electronic device.

The first and second external electrodes 81 and 82 may be formed of a conductive paste containing a conductive metal, wherein the conductive metal may be at least one of copper (Cu), nickel (Ni), tin (Sn), and silver (Ag), or an alloy thereof.

The first and second external electrodes may contain plating layers formed on paste layers, respectively.

The plating layer may contain any one or more selected from the group consisting of nickel (Ni), copper (Cu), and tin (Sn). For example, nickel (Ni) layers and tin (Sn) layers may be sequentially formed.

Hereinafter, a manufacturing method of an inductor according to exemplary embodiments of the present disclosure will be described.

A description of the same components as those of the inductor of FIGS. 1 through 5 will be omitted.

The manufacturing method of an inductor according to exemplary embodiments of the present disclosure may include: forming a coil part including a coil layer; and forming a body accommodating the coil part therein, wherein the coil layer includes a coil pattern having a spiral shape and a lead terminal extended from the coil pattern and exposed to the outside of the body, the lead terminal having the same width as that of the coil pattern.

First, a via may be formed in a support member.

The via may be formed using a photo-lithography method and/or a plating method.

The via may be formed of a conductive material such as copper (Cu), aluminum (Al), silver (Ag), tin (Sn), gold (Au), nickel (Ni), lead (Pb), an alloy thereof, or the like.

According to the present disclosure, since the via is formed in the coil pattern using the photo-lithography method and the plating method, a processing process for forming a through hole in the support member may be omitted, such that manufacturing cost may be decreased.

Next, first and second coil layers may be obtained by performing the plating on upper and lower surfaces of the support member.

After a pattern is formed on upper and lower surfaces of an insulating layer by a photo-lithography method, a base pattern may be formed by performing isotropic plating.

Thereafter, a width of a coil pattern may be increased by further performing the isotropic plating.

In detail, a seed pattern may be formed on the upper surface of the support member.

The seed pattern may be formed of silver (Ag), palladium (Pd), aluminum (Al), nickel (Ni), gold (Au), copper (Cu), platinum (Pt), or an alloy thereof.

The seed pattern may be formed on the surface of the support member by a sputtering method, or the like, using a seed material for performing a subsequent plating process.

Next, a photo resist pattern may be formed on the seed pattern.

The photo resist pattern may be formed by coating, exposing and developing a photo resist.

The photo resist pattern may be formed of a positive type photo resist or negative type photo resist.

The photo resist pattern may be formed by applying the photo resist on the seed pattern and removing a region of the photo resist to be plated.

Next, a conductive material may be formed by plating a metal on a surface of the seed pattern exposed between the photo resist patterns.

The metal may include at least one of gold, silver, platinum, copper, nickel, and palladium or an alloy thereof. The plating may be performed by an electroplating method.

Then, the base pattern may be formed by removing the photo resist pattern. The base pattern may include the conductive material and the seed pattern.

Next, the coil layer including the coil pattern and the lead terminal may be formed by etching the base pattern.

The etching may be performed in order to remove the seed pattern exposed between the patterns from the base pattern, and a wet etching method, reactive ion etching (IE) method, or a dry etching method such as an ion beam milling method, or the like, may be used.

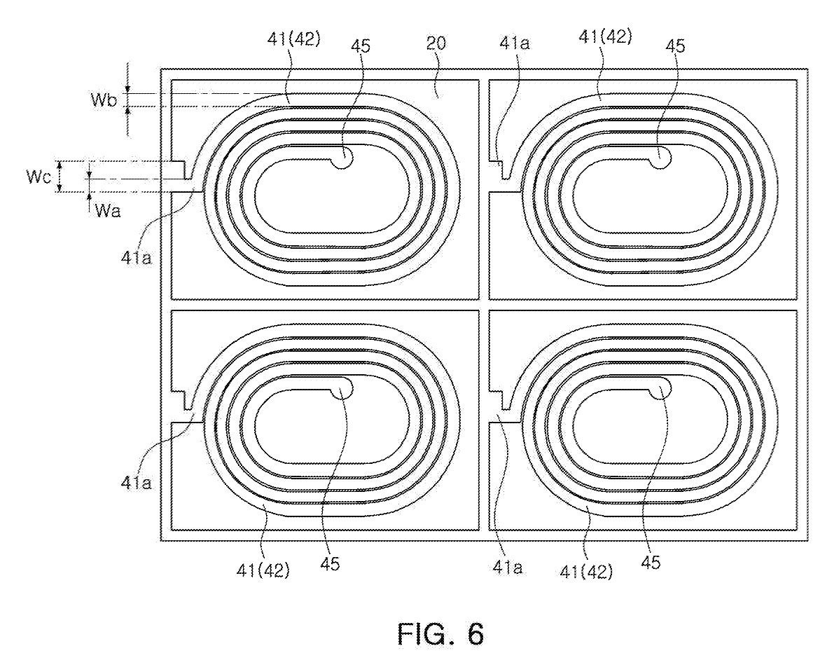

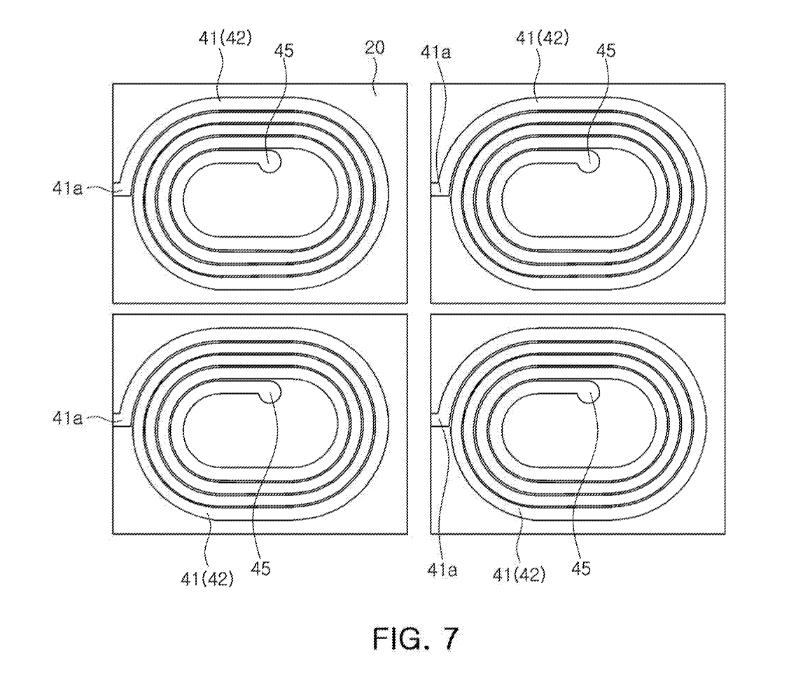

FIGS. 6 and 7 are process cross-sectional views for describing a manufacturing method of an inductor according to exemplary embodiments of the present disclosure.

Referring to FIG. 6, a pattern including coil layers 41 and 42 may be formed on the support member 20.

The pattern may be in a form in which the plurality of coil layers 41 and 42 are connected to each other.

When the width of the lead terminal is wider than the width of the coil pattern, at the time of development of the photo resist serving as a partition, a bending phenomenon of a lead terminal line may occur. The reason is that at the time of drying after development, due to a difference in drying rate of a washing solution between the lead terminal having a relatively wide width and the coil pattern having a relatively narrow width, the lead terminal line is bent toward the coil pattern having a narrow width.

According to exemplary embodiments of the present disclosure, the lead terminal extended from the coil pattern of the coil layer may be formed so that the width Wa of the lead terminal is the same as the width Wb of the coil pattern by patterning a region to become the lead terminal of the coil pattern in an “L” shape.

A collapsing problem of the lead terminal may be solved by decreasing a region of the lead terminal.

Next, referring to FIG. 7, the coil part may be obtained by dicing the rest regions except for the plurality of coil layers 41 and 42.

A width We of the pattern connected to the lead terminal may be wider than the width Wa of the lead terminal, and a shape of the lead terminal may be changed depending on a dicing position.

A defect occurring at the time of dicing the pattern may be decreased due to a decrease in the width of the lead terminal.

As set forth above, according to exemplary embodiments of the present disclosure, the pattern defect and the chipping defect of the body may be decreased by changing the shape of the lead terminal of the coil layer.

While exemplary embodiments have been shown and described above, it will be apparent to those skilled in the art that modifications and variations could be made without departing from the scope of the present disclosure as defined by the appended claims.

What is claimed is:

1. An inductor, comprising:
a body; and
a coil part disposed in the body, the coil part including a coil layer, the coil layer including a coil pattern having a spiral shape and a lead terminal extended from the coil pattern and exposed to an outside of the body,
wherein a width of the lead terminal is the same as that of the coil pattern.

2. The inductor of claim 1, wherein the lead terminal has a pattern having an “L” shape.

3. The inductor of claim 2, wherein a space between the lead terminal and the coil pattern is filled with a material at least partially forming the body, the lead terminal being spaced apart from the coil pattern in a length direction of the body.

4. The inductor of claim 1, wherein the lead terminal includes a plurality of protrusion portions.

5. The inductor of claim 4, wherein one or more spaces between the plurality of protrusion portions is filled with a material forming at least a portion of the body.

6. The inductor of claim 1, wherein the coil layer is formed by plating.

7. The inductor of claim 6, wherein the coil part includes a support member, a first coil layer formed on one surface of the support member, and a second coil layer formed on another surface of the support member.

8. A manufacturing method of an inductor, the manufacturing method comprising:
forming a coil part including a coil layer; and
forming a body accommodating the coil part therein,
wherein the coil layer includes a coil pattern having a spiral shape and a lead terminal extended from the coil pattern and exposed to the outside of the body, and
wherein the lead terminal has the same width as that of the coil pattern.

9. The manufacturing method of claim 8, wherein the lead terminal has a pattern having an “L” shape.

10. The manufacturing method of claim 8, wherein the lead terminal includes a plurality of protrusion portions.

11. The manufacturing method of claim 8, wherein the coil layer is formed by plating.

12. An inductor, comprising:
a body; and
a coil part disposed in the body, the coil part including a coil layer, the coil layer including a coil pattern having a spiral shape and a lead terminal extended from the coil pattern and exposed to an outside of the body,
wherein a width of a portion of the lead terminal proximate the outside of the body is greater than a width of a portion of the lead terminal proximate the coil layer.

13. The inductor of claim 12, wherein the lead terminal has a pattern having an “L” shape.

14. The inductor of claim 11, wherein a space between the lead terminal and the coil pattern is filled with a material at least partially forming the body, the lead terminal being spaced apart from the coil pattern in a length direction of the body.

15. The inductor of claim 11, wherein the lead terminal includes a plurality of protrusion portions.

16. The inductor of claim 15, wherein one or more spaces between the plurality of protrusion portions is filled with a material forming at least a portion of the body.
